(19) United States
(12) Patent Application Publication
(10) Pub. No.: US 2012/0328316 A1
(43) Pub. Date: Dec. 27, 2012

(54) METHOD AND DEVICE FOR THE PRINTING OF SUBSTRATES

(76) Inventors: Eckhard Bauer, Kiel (DE); Karlheinz Peter, Molfsee (DE); Douglas Joseph Kostyk, Victor, NY (US)

(21) Appl. No.: 13/518,396

(22) PCT Filed: Dec. 23, 2009
(86) PCT No.: PCT/EP2009/067836

§ 371 Date: Sep. 13, 2012

(51) Int. Cl. B41J 29/38; G03G 13/20; G03G 15/20

(52) U.S. Cl. 399/68; 347/16

(57) ABSTRACT

The present invention relates to a method for the printing of substrates, wherein the substrates are printed at a printing speed and the thusly produced printed image is subsequently fused at a speed that is lower than the printing speed. After the entire substrate has moved through the fusing unit (9), the substrate is accelerated to a transport speed A device in accordance with the invention comprises at least one printing unit (5) for the application of a printing medium to the substrate, a first transport unit (7) for transporting the substrate past the at least one printing unit, as well as a fusing unit for fusing the printing medium, like toner or ink, on the substrate, and a second transport unit (10) for transporting the substrate through the fusing unit Furthermore, the device comprises a third transport unit (11), the listed transport units being arranged in the sequence given above A control unit that also is part of the device is suitable for driving the aforementioned transport units at different speeds m such manner that the transport of the substrate by the second transport unit is slower than by the first transport unit, while the third transport unit causes the substrates leaving the fusing unit to be accelerated.

### TECHNICAL FIELD OF THE INVENTION

The present invention relates to a method and a device for the printing of substrates, wherein the substrates are printed at a printing speed and the thusly produced printed image is subsequently fused at a speed that is lower than the printing speed.

### BACKGROUND ART

In the art, it has generally been known that printing images that have been produced, for example, of toner or ink are fused by means of heat, following the application to a substrate. In conjunction with this, fusing is understood to mean a melt-depositing of toner or a drying of ink. When melt-depositing toner and when drying ink, it is desirable that this be accomplished with the least possible use of energy. In this case, the energy required for fusing, which has to be provided by a fusing unit, depends—among other things—on the applied quantity of toner material or ink, on the speed of the substrate within the fusing unit, as well as on the type and quality of the substrate.

With the usual printing machines, the substrates are printed and fused at the same speed. The result of this is that at higher printing speeds in the fusing unit it is necessary, as a rule, to provide higher temperatures in order to be able to inject sufficient energy into the printing image or the substrate. For the applied printing image to be completely fused, a quantity of energy ensuring such fusing must be provided in the fusing unit. This, however, causes problems because certain substrates such as, for example, films are not suitable for higher temperatures.

A known fusing unit that is generally used for toner applications comprises a heatable fusing roller and a pressure roller, said rollers forming a fusing nip for the passage of a substrate. In order to lengthen the fusing nip in transport direction of the substrate and to thus increase a contact area between the substrate and the fusing roller, the pressure roller usually has an elastic surface that is compressed in the region of the fusing nip. Thus, the contact area between the substrate and the fusing roller can be varied depending on the pressure in the fusing nip. However, at high fusing speeds in such fusing units, there is the risk that the substrate warps in the region of the fusing nip or that the substrate winds around the fusing roller. In order to prevent this and an adhesion of toner particles to the fusing roller, it has been known to use a separating oil on the fusing roller, which, however, could again lead to other problems.

In order to avoid such warping of the substrate or winding of the substrate on the fusing roller in such a fusing unit and in order to ensure the most efficient possible energy transfer for fusing, the substrate weights that may be processed in the printing machine are usually restricted to a specific range.

### SUMMARY OF THE INVENTION

Accordingly, it is the object of the present invention to provide a solution for avoiding or reducing substrate restrictions on account of higher process speeds during the fusing operation. This is to be accomplished by a device and/or by a method that avoid the aforementioned problems.

In accordance with the invention, a method for printing a substrate in accordance with Claim 1 and a device for printing a substrate in accordance with Claim 13 are provided. The method, in particular, consists of printing the substrate at a printing speed and subsequently fusing it in a fusing unit at a fusing speed that is lower than the printing speed. After the entire substrate has moved through the fusing unit, the substrate is accelerated to a transport speed.

Due to the reduction of the fusing speed relative to the printing speed in accordance with the invention, it is possible to reduce the frequency of transport errors within the fusing unit due to high fusing speeds and to avoid the occurrence of such errors, respectively. In particular, the reduction of the fusing speed also allows an improved energy transfer to the substrate. As a result of this, it is possible, for example, to reduce the contact area between the substrate and the fusing roller, the latter being used for energy transfer. As a result of this, it might be possible to avoid the use of the separating oil or to, at least, reduce the amount that is being used, thus minimizing the problems associated therewith. However, if the contact area is not reduced, a more gradual heating of the substrate may occur, thus improving the transfer of energy.

Beyond that, due to the acceleration of the substrates to the transport speed after the fusing operation, it can be easily ensured that substrates can be fed, for example, for duplex printing, said duplex printing again taking place at a higher printing speed.

Preferably, at least two successive substrates are printed, said substrates displaying a first distance between them when they are being printed at the printing speed. During subsequent fusing at the fusing speed, the substrates display a third distance that is smaller than the first distance. While the substrates are being transported at the transport speed, said substrates may then display a fourth distance that, in turn, is greater than the third distance. By changing the distances that result from the individual speed changes, it is possible to ensure a continuous printing of the substrates at high printing speeds, despite the lower fusing speeds.

In conjunction with this, it should be considered that, by reducing the first distance to the third distance while the substrates are being printed, it is possible to prevent the substrates from overlapping and/or warping at the fusing speed while the substrates are being fused.

Preferably, after printing the substrate, the substrate is transferred to the fusing unit at a transfer speed, whereby the substrates may display a second distance during transfer at the transfer speed.

As a result of this, the transfer of the substrates to the fusing unit can be achieved in two steps. While being printed, the substrates are electrostatically fused to a transport belt. They are then transferred at a transfer speed to the fusing unit, thus changing the transport speed of the substrates in two steps.

The advantage here is that the changes of the speed of the substrate do not occur at a location, e.g., the fusing unit, but that a change of the speed already takes place beforehand and that only then the substrate is fed to the fusing unit.

Preferably, the second distance is changed with respect to the first distance, and the third distance of the substrates at the fusing unit essentially approaches zero. This means that the distance between the substrates is closed or that the distance is minimal.

Preferably, the fourth distance displayed by the substrates after being fused is essentially equal to the first distance. This offers the advantage that, for two-sided printing of the substrates, said substrates can be directly moved into the duplex path in order to thus enable printing of the second side.

In one embodiment of the invention, the printing speed may be selected in such a manner that it is higher than the transfer speed and that, in turn, the transfer speed is lower than or equal to the fusing speed. As a result of this, it can be achieved that a critical region, namely the region in which the substrate is decelerated, is not at the fusing unit. For this, the substrate is decelerated and subsequently moved into the fusing unit at a slightly higher speed or at the same speed.

In another embodiment of the invention, the printing speed may be selected so as to be higher than the transfer speed while, in turn, the transfer speed is higher than the fusing speed. As a result of this, the deceleration of the substrate takes place in two steps, thus resulting in two critical regions in which the speed must be reduced, this featuring the advantage that no excessively strong deceleration of the substrate occurs in any of the two regions.

In accordance with one embodiment, the printing speed may be lower than or equal to the transfer speed. As a result of this, a critical region between the printing speed and the transfer speed is nearly avoided, and the deceleration of the substrate to the fusing speed occurs entirely at the fusing unit. The advantage of such an embodiment is that a critical region between the printing speed and the transfer speed is avoided, thus preventing negative effects of a deceleration of the substrate on the printing process.

Furthermore, the printing speed may essentially be equal to the transport speed. As a result of this, a direct feeding of the substrate into the duplex path and the subsequent printing of the second side of the substrate can be easily achieved without any additional control effort.

In accordance with one embodiment of the invention, the substrate may be electrophotographically printed with the use of a dry or liquid toner, or ink jet with the use of an ink, and the toner or ink may be subsequently fused.

In order to ensure that the substrates are accelerated downstream of the fusing unit from the fusing speed to the printing speed, it is possible, in accordance with one embodiment, for an accelerating unit to be moved out of a moving path of the substrate during the fusing operation and to be contacted and accelerated after the substrate has been completely fused.

Such a procedure causes the acceleration of the substrate to occur only once said substrate has completely left the fusing unit. Consequently, this prevents the substrate from being pulled out of the fusing unit or the acceleration rollers from sliding with a certain slippage over the surface of the previously fused toner and thus from damaging the surface.

A device in accordance with the invention comprises at least one printing unit for the application of a printing medium to the substrate, a first transport unit for transporting the substrate past the at least one printing unit, as well as a fusing unit for fusing the printing medium, like toner or ink, on the substrate, and a second transport unit for transporting the substrate through the fusing unit. Furthermore, the device comprises a third transport unit, the listed transport units being arranged in the sequence given above. A control unit that also is part of the device is suitable for driving the aforementioned transport units at different speeds in such manner that the transport of the substrate by the second transport unit is slower than by the first transport unit, while the third transport unit causes the substrates leaving the fusing unit to be accelerated.

In accordance with one embodiment of the invention, the device may comprise a transfer transport unit, said unit being arranged between the first and the second transport units. The advantage here is that a certain disengagement of the decelerating process of the substrates from the first transport unit to the second transport unit may be accomplished.

In accordance with one embodiment, the control unit may be suitable for driving the transport units in such a manner that the first transport unit features a printing speed, the transfer transport unit features a transfer speed, and the second transport unit features a fusing speed. In this case, the printing speed is higher than the transfer speed, and the transfer speed, in turn, is lower than or equal to the fusing speed.

In accordance with an alternative embodiment, the control unit may be suitable for driving the first transport unit at a printing speed, the transfer transport unit at a transfer speed, and the second transport unit at a fusing speed. In this case, the printing speed is higher than the transfer speed, and the transfer speed, in turn, is higher than the fusing speed.

In an alternative embodiment, the control unit may be configured in such a manner that the first transport unit is driven at a printing speed, the transfer transport unit at a transfer speed, and the second transport unit at a fusing speed. In this case, the printing speed is lower than or equal to the transfer speed, and the transfer speed, in turn, is higher than the fusing speed.

In accordance with one embodiment, the control unit may further be suitable for driving the first transport unit at a printing speed and the third transport unit at a transport speed. In this case, the printing speed is selected so as to be equal to the transport speed.

In accordance with one embodiment, it is possible to move the third transport unit away from a path of movement of the substrate and toward said path of movement. In this instance, the control unit is suitable for controlling the third transport unit in such a manner that said control unit contacts a substrate only when said substrate has completely left the fusing unit. In this case, the third transport unit is preferably supported in such a manner that the movement toward or away from the path of movement of the substrate can be accomplished by a pivoting motion. However, a position control of the third transport unit can be achieved also in different ways such as, e.g., via lifting magnets that are mounted to the third transport unit.

In accordance with one embodiment, the third transport unit comprises at least one pair of rollers for accelerating the substrate. An acceleration of the substrate by means of a roller pair represents a simple solution for accelerating the substrates. In addition, the rollers, as previously mentioned, can be easily brought into selective contact with the substrate.

In an alternative embodiment, the third transport unit may comprise a plurality of roller pairs. As a result of this, a reliable contacting of the substrates can be achieved.

In accordance with another embodiment of the invention, it is possible to individually actuate the plurality of roller pairs. This allows a slowly increasing acceleration of the substrate. For this, a first pair of rollers can be used for a first acceleration, and additional pairs of rollers can be used for the stepped acceleration of the substrate to the desired final speed. The advantage here is that excessive acceleration by one roller pair is prevented; thus the risk of slippage on one pair of rollers is minimized because potentially occurring slippage can lead to quality losses on the surface of the substrates.

In accordance with one embodiment, the device may be characterized in that the at least one printing unit is an electrophotographic printing unit or an ink jet printing unit.

In an alternative embodiment, the device may be characterized by a duplex path that is disposed for the transport of a substrate from the third transport unit to the first transport unit.

### BRIEF DESCRIPTION OF THE DRAWINGS

Hereinafter, the invention will be described in greater detail with reference to the drawing. It shows in

FIG. 1 a schematic side view of a printing machine.

### DETAILED DESCRIPTION OF THE INVENTION

Information regarding locations or directions used in the description hereinafter primarily relate to the illustration in the drawings and should thus not be viewed as being restrictive. However, such information could also relate to a preferred final arrangement.

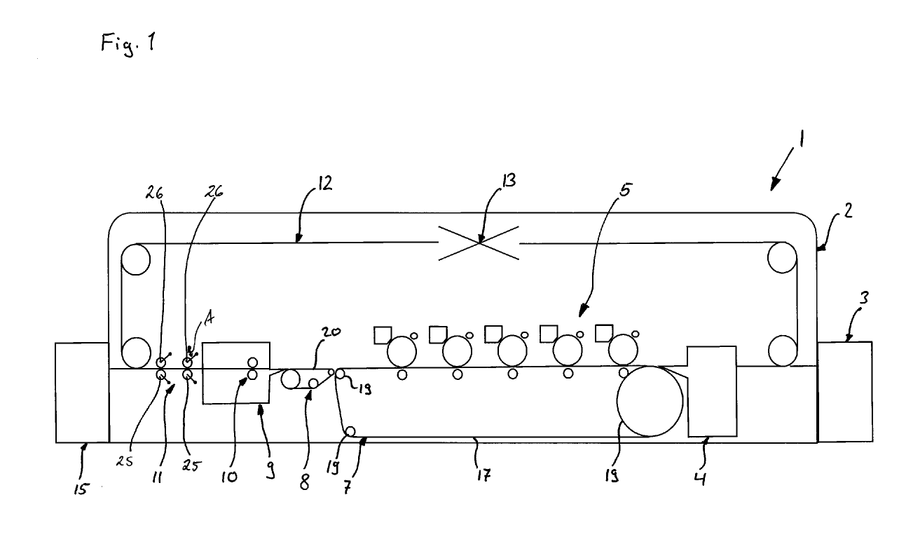

FIG. 1 shows a schematic side view of a multi-color printing machine 1 comprising an apparatus housing 2, a feeder 3, an alignment unit 4, a plurality of printing units 5, a first transport unit 7, a transfer unit 8, a fusing unit 9, a second transport unit 10, a third transport unit 11, a duplex path 12 with a turning unit 13, as well as an output tray 15.

The most diverse embodiments of such multi-color printing machines have been known, FIG. 1 representing only a highly simplified example thereof.

The apparatus housing 2 encloses the different units of the multi-color printing machine 1 with the exception of the feeder 3 and the output tray 15, these representing external units in the shown embodiment. However, they may also be integrated in the apparatus housing 2 as has been known in the art. The apparatus housing 2 acts as protection of the units inside the apparatus housing 2 against contaminants and against unauthorized access. In addition, the apparatus housing 2 also acts as protection for the operators of the multi-color printing machine 1.

The feeder 3 is disposed for receiving a stack of sheets and for the individual feeding of sheets from the stack of sheets to the alignment unit 4. The alignment unit 4 is of a suitable type that aligns fed sheets and transfers them to the first transport unit 7. Again, the first transport unit 7 is of a known type that is suitable for transporting sheets past the printing units 5. In the illustrated embodiment, the first transport unit 7 comprises a circulating transport belt 17 that is moved around appropriate transport and guide rollers 19.

The printing units 5 are arranged relative to the first transport unit in such a manner that they are suitable for printing the respective color separations on the sheets that are transported by the first transport unit 7. The illustrated multi-color printing machine 1 shows five printing units that can be operated, for example, with the colors black, cyan, magenta, yellow and one custom ink such as, for example clear dry ink. Each of the printing units 5 is of a known clectrophotographic type that applies toner images to the respective sheets. However, the printing units 5 may also be of the so-called ink jet type, this type being used for the application of ink to the respective sheets.

The transfer unit 8 is located between the first transport unit 7 and the fusing unit 9. The transfer unit 8 is disposed for transporting the sheets between the first transport unit 7 and the fusing unit 9. The transfer unit is configured as a suction belt transport mechanism comprising a circulating suction belt 20.

Even though the transfer unit 8 is shown in FIG. 1 and is part of one embodiment of the invention, it should be noted that said transfer unit could also be omitted. In this case, the fusing unit would directly follow the first transport unit.

The fusing unit 9 is of the type comprising a heatable fusing roller and a pressure roller that form a fusing nip between them. In addition, the fusing roller and the pressure roller also represent the second transport unit 10, or at least a part thereof. Consequently, the second transport unit 10 is arranged in the fusing unit 9. The pressure roller and the heated fusing roller are thus not only used for transferring the energy required for fusing but are also used for transporting the substrate through the fusing unit 9. Furthermore, the fusing unit comprises a not specifically illustrated cooling unit for cooling the sheets after the fusing operation.

Alternatively, it is also possible to provide other suitable fusing devices such as, for example, a contactless heating device that operates with light or different electromagnetic radiation such as, for example microwaves.

Likewise, a drying device may operate, for example, with light or electromagnetic radiation or hot air in order to provide for drying the ink. In this case, a suitable second transport unit would have to be provided in the fusing unit.

The third transport unit 11 is arranged adjacent to an output of the fusing unit 9 and is disposed for accelerating sheets when said sheets arc leaving said fusing unit 9. The third transport unit 11 comprises two pairs of rollers, each pair having a lower driving roller 25 and an upper pressure roller 26. The rollers 25 and 26 can be moved toward each other and away from each others in order to form a transport nip between them or to allow free feeding of the sheets between them. In particular, the rollers 25, 26 are pivotally supported, as is indicated by the double arrow A in FIG. 1.

Even though FIG. 1 shows the lower rollers 25, as well as the upper rollers 26, as being pivotally supported, it is also possible to pivotally support only the upper rollers 26 or only the lower rollers 25. For a simplification of the design, only the pressure rollers should be pivotally supported and the driving roller should be arranged so as to be stationary.

Viewed in transport direction, a not specifically illustrated diverter is located downstream of the third transport unit, said diverter deflecting a sheet conveyed by the third transport unit either in the direction of the duplex path 12 or toward the output tray 15.

In a manner known per se, the duplex path 12 forms a substrate-conveying path back to the alignment unit 4. A turning device 13 is provided in the duplex path 12, said turning device being disposed for turning a substrate conveyed in the known manner along the duplex path 12 for verso-printing.

Hereinafter, the operation of the printing machine 1 will be explained in greater detail.

Generally, printing units 5 are used to print toner images on sheets, said toner images being subsequently fused in the fusing unit 9. Subsequently, the sheets arc moved to the output tray 15 or directed into the duplex path 12. Sheets entering the duplex path 12 are turned for verso-printing and are then again printed with toner images that, in turn, arc fused again. Finally, the duplex-printed sheets are fed to the output tray.

In particular, the feeder 3 is disposed to place individually separated sheets on the alignment unit 4, said sheets being aligned in a suitable manner in said alignment unit. Subsequently, the sheets are individually transferred to the first transport unit 7 at a prespecified first distance from the respectively previous sheet. In a manner known per se, the sheets are electrostatically held on the transport belt 17 of the first transport unit 7 and are thus securely held to prevent them from slipping. Then, the first transport unit 7 transports the sheets past the printing units 5, the toner images being applied in the known manner in said printing units. The sheets are transported through the first transport unit 7 at a first speed, the transport speed.

Thereafter, the sheets are transferred from the first transport unit to the transfer unit 8, said transfer unit conveying the sheets to the fusing unit 9.

The suction belt 20 of the transfer unit is driven at a transfer speed that is lower than the printing speed. During the transfer of the sheet from the transport belt 17 to the suction belt 20—depending on the thickness of the sheet and the strength of the suction action on the suction belt—the sheet is being warped and/or the sheet slips on the suction belt. This has the effect that the prespecified first distance between successive sheets on the first transport unit 7 is reduced to a second distance on the suction belt 20.

As soon as the sheet has completely left the transport belt 17 and is now transported by the suction belt 20 alone, the sheet is transported at the transfer speed to the fusing unit 9.

At the fusing unit 9, the sheet is accepted by the second transport unit 10. The second transport unit 10 transports the sheet at a fusing speed. The fusing speed is lower than the transfer speed of the transfer unit 8. Consequently, while the second transport unit 10 accepts the sheet, said sheet—depending on the thickness of the sheet and the strength of the suction action on the suction belt—is, again, being warped and/or the sheet slips on the suction belt 20. As a result of this, the second distance on the suction belt is again reduced to a third distance in the fusing unit, which may approach zero. The only event to be avoided is that successive sheets overlap each other.

Alternatively, the speed of the transfer unit 8 may be controlled by means of different control modes of a control unit in such a manner that the transfer speed is higher than or equal to the printing speed. As a result of this, the second distance would initially become greater than the first distance, or be equal to the second distance. Likewise, the transfer speed may also be controlled in such a manner that it is equal to the fusing speed. In each of these modes, the fusing speed is—at any rate—lower than the printing speed, so that the third distance of the sheets in the fusing unit is smaller than the first distance of the sheets during the printing operation.

A respective sheet is transported within the fusing units 9 at the fusing speed, and the toner image is fused by means of heat application in the region of the fusing nip between the fusing roller and the pressure roller, said pressure roller ensuring the transport of the sheets at the same time.

A respective sheet is then transported at the fusing speed in the region of the third transport unit 11, with the rollers 25, 26 of the roller pairs having been moved apart in order to be able to essentially freely feed the sheet between said rollers. It is, however, possible that the lower driving rollers contact and support the sheet.

As soon as the respective sheet is completely free, i.e., has left the fusing nip or the fusing unit, the roller pairs are moved toward each other to form a transport nip, and the sheet is subsequently accelerated to a transport speed by the third transport unit 11.

Due to the acceleration of the sheets to a higher speed, the third distance that existed inside the fusing unit 9 is increased to a fourth distance. The transport speed is essentially equal to the printing speed, so that the fourth distance is essentially equal to the first distance of the sheets.

Thereafter, the sheet is conveyed to the output tray 15 or—via the duplex path 12 and the turning unit 13—back to the alignment unit 4 in order to move through an additional printing process with subsequent fusing, in which process the same speeds as previously described may be set.

Hereinabove, the invention was explained in greater detail with reference to preferred embodiments of the invention, without being restricted to the specifically illustrated embodiments.

1. A method for printing on a substrate, said method comprising:
printing the substrate at a printing speed;
fusing the substrate in a fusing unit at a fusing speed that is lower than the printing speed; and
accelerating the substrate to a transport speed after the substrate has been fused and has completely moved through the fusing unit.

2. The method according to claim 1, wherein at least two successive substrates are printed on, the substrates displaying a first distance between them when they are being printed on at the printing speed, displaying a third distance that is smaller than the first distance during subsequent fusing at the fusing speed, and displaying a fourth distance during transport at the transport speed.

3. The method according to claim 2, further including, after the printing step, transferring the substrate at a transfer speed to the fusing unit, wherein the substrates display a second distance during transfer at the transfer speed.

4. The method according to claim 3, wherein the second distance is changed with respect to the first distance, and the third distance essentially approaches zero.

5. The method according to claim 2, wherein the fourth distance essentially corresponds to the first distance.

6. The method according to claim 3, wherein the printing speed is higher than the transfer speed, and the transfer speed is lower than or equal to the fusing speed.

7. The method according to claim 3, wherein the printing speed is higher than the transfer speed, and the transfer speed is higher than the fusing speed.

8. The method according to claim 3, wherein the printing speed is lower than or equal to the transfer speed.

9. The method according to claim 1, wherein the printing speed is essentially equal to the transport speed.

10. The method according to claim 1, wherein the printing step included electrophotographically applying a toner or using an ink jet to apply an ink to the substrate, and subsequently fusing.

11. The method according to claim 1, wherein the substrate is printed on both sides.

12. The method according to claim 1, further including moving an accelerating unit out of the moving path of the substrate during the fusing operation, and contacting and accelerating the substrate with the accelerating unit after the substrate has been completely fused.

13. A device for printing on a substrate, the device comprising:
at least one printing unit for the application of a printing medium to the substrate;
a first transport unit for transporting the substrate past the at least one printing unit;
a fusing unit for fusing the printing medium on the substrate;
a second transport unit for transporting the substrate through the fusing unit;
a third transport unit, the listed transport units arranged in the sequence given above; and
a control unit adapted to drive the transport units at different speeds so that that the transport of the substrate by the second transport unit is slower than by the first transport unit, with the third transport unit causing the substrates leaving the fusing unit to be accelerated.

14. The device according to claim 13, wherein the device includes a transfer transport unit arranged between the first and the second transport units.

15. The device according to claim 13, wherein the control unit is further adapted to drive the transport units in such manner that the first transport unit displays a printing speed, the transfer transport unit displays a transfer speed, and the second transport unit displays a fusing speed, with the printing speed being higher than the transfer speed and the transfer speed being lower than or equal to the fusing speed.

16. The device according to claim 13, wherein the control unit is adapted to drive the first transport unit at a printing speed, the transfer transport unit at a transfer speed, and the second transport unit at a fusing speed, with the printing speed being higher than the transfer speed, and the transfer speed being higher than the fusing speed.

17. The device according to claim 13, wherein the control unit is adapted to drive the first transport unit at a printing speed, the transfer transport unit at a transfer speed, and the second transport unit at a fusing speed, with the printing speed being lower than or equal to the transfer speed, and the transfer speed being higher than the fusing speed.

18. The device according to claim 13, wherein the control unit is adapted to drive the first transport unit at a printing speed, and the third transport unit at a transport speed, with the printing speed being equal to the transport speed.

19. device according to claim 13, wherein the third transport unit is movable away from a path of movement of the substrate and toward the path of movement, with the control unit further adapted to control the third transport unit so that the transport unit contacts a substrate only when the substrate has completely left the fusing unit.

20. The device according to claim 13, wherein the third transport unit includes at least one roller pair for accelerating the substrate.

21. The device according to claim 13, wherein the third transport unit includes a plurality of roller pairs.

22. The device according to claim 21, wherein the roller pairs of the plurality of roller pairs can be individually actuated.

23. The device according to claim 13, wherein the at least one printing unit is an electrophotographic printing unit or an ink jet printing unit.

24. The device according to claim 13, further including a duplex path adapted to transport the substrate from the third transport unit to the first transport unit.

25. The device according to claim 13, wherein the printing medium includes light toner or ink.
